(19) United States
(12) Patent Application Publication
(10) Pub. No.: US 2019/0381648 A1
(43) Pub. Date: Dec. 19, 2019

(54) POWER TOOL WITH TAPPING MODE

(71) Applicant: BLACK & DECKER INC., New Britain, CT (US)

(72) Inventor: Peter Hague Wadeson, Silver Spring, MD (US)

(21) Appl. No.: 16/417,749

(22) Filed: May 21, 2019

Related U.S. Application Data
(60) Provisional application No. 62/686,855, filed on Jun. 19, 2018.

(51) Int. Cl. B25F 5/00; H02P 6/30; B25F 5/02; B25B 21/00; B25B 21/02; B25B 23/147

(52) U.S. Cl. CPC B25F 5/001; H02P 6/30; B25B 23/147; B25B 21/002; B25B 21/026; B25F 5/02

(57) ABSTRACT

A power tool includes a housing, a motor disposed in the housing and configured to rotationally drive an output member, a power delivery switch coupled to the housing and actuatable to cause power to be delivered to the motor, and a tool holder rotationally driven by the output member to rotatably drive at least one of a drill bit, a socket, a fastening bit, a tool bit holder, and a tapping bit. A controller in the housing is configured to control power delivery to the motor in a user selected driving mode or tapping mode. In the driving mode, the controller causes the motor to be driven in a first direction when the power delivery switch is actuated. In the tapping mode, the controller causes the motor to be driven in alternating directions while the power delivery switch is continuously actuated, such that the motor is driven in the first direction for a first time period until a first tool operation parameter reaches a first threshold value and in an opposite second direction for a second time period until a second tool parameter reaches a second threshold value.

### RELATED APPLICATIONS

This application claims priority under 35 U.S.C. § 119 to U.S. Provisional Application No. 62/686,855, titled “Power Tool with Tapping Mode,” filed Jun. 19, 2019, which is incorporated by reference.

### TECHNICAL FIELD

This application relates to a power tool, such as a drill, impact driver, or impact wrench, with a tapping mode of operation.

### BACKGROUND

Power tools such as drills, impact drivers, and impact wrenches, are generally designed for driving drill bits to cut holes and/or driving, installing, or removing threaded fasteners, such as screws, bolts, and nuts. In normal operation, such power tools are operated in a single direction selected by a user (e.g., forward to drill a hole or install a threaded fastener or reverse to remove a drill bit from a drilled hole or to remove a threaded fastener). Some users use such power tools with tapping bits, which are bits specially designed to cut female threads into an opening in a workpiece.

### SUMMARY

In an aspect, a power tool includes a housing, a motor disposed in the housing and configured to rotationally drive an output member, a power delivery switch coupled to the housing and actuatable by a user to cause power to be delivered to the motor, and a tool holder configured to be rotatably driven by the output member. The tool holder is configured to rotatably drive at least one of a drill bit, a socket, a fastening bit, a tapping bit, and a tool holder accessory. A controller is disposed in the housing, coupled to the power delivery switch and to the motor, and configured to control power delivery to the motor in one of a driving mode and a tapping mode as selected by a user. In the driving mode, the controller causes the motor to be driven in a first direction when the power delivery switch is actuated by a user. In the tapping mode, the controller causes the motor to be driven in alternating directions while the power delivery switch is continuously actuated by a user, such that the motor is driven in the first direction for a first time period until a first tool operation parameter reaches a first threshold value, followed by the motor being driven in an opposite second direction for a second time period until a second tool parameter reaches a second threshold value.

Implementations of this aspect may include one or more of the following features. The first tool parameter may comprise at least one of a first time of operation, a first amount of rotation of the output member, a first rotational speed of the output member, a first amount of torque on the output member, and a first amount of current drawn by the motor, and the first threshold value may comprise at least one of a first time threshold value, a first rotation threshold, a first speed threshold, a first torque threshold, and a first current threshold, respectively. The second tool parameter may comprise at least one of a second time of operation, a second amount of rotation of the output member, a second rotational speed of the output member, a second amount of torque on the output member, and a second amount of current drawn by the motor, and the second threshold value may comprise at least one of a second time threshold value, a second rotation threshold, a second speed threshold, a second torque threshold, and a second current threshold, respectively. A mode selector switch may be coupled to the housing and operable by a user to select among a plurality of modes that include the driving mode and the tapping mode.

When operating in the tapping mode, the controller may be configured to stop the motor for a third time period between the first time period and the second time period. When operating in the tapping mode, controller may be configured to stop the motor for a fourth time period after the second time period and before the next first time period. Each of the first threshold value and the second threshold value may be fixed or may be user-adjustable. A wireless communications module may be coupled to the controller, where the first threshold value and the second threshold value are user-adjustable via a remote computing device configured to wirelessly communicate with the wireless communications module. The first threshold value and the second threshold value may be selected such that the first time period is greater than the second time period. The first threshold value may be selected to be sufficient to cause the tool holder to rotate by more than one full revolution under a no load condition. When operating in the tapping mode, the controller may cause the motor to rotate at a first constant motor speed during the first predetermined period and at a second constant motor speed during the second predetermined time period. The first constant motor speed and the second constant motor speed may be user-adjustable. The power tool may be one of a drill, a drill-driver, an impact driver, and an impact wrench.

In another aspect, a power tool includes a housing, a motor disposed in the housing and configured to rotationally drive an output member, a power delivery switch coupled to the housing and actuatable by a user to cause power to be delivered to the motor, and a tool holder configured to be rotatably driven by the output member to rotatably drive a tapping bit. A controller is disposed in the housing and coupled to the power delivery switch and to the motor. The controller is configured to control power delivery to the motor in a tapping mode in which the controller causes the motor to be driven in alternating directions while the power delivery switch is continuously actuated by a user, such that the motor is driven in a first direction for a first time period and in a second opposite direction for a second time period. The first time period is sufficient to cause the output member to rotate by more than one full revolution.

Implementations of this aspect may include one or more of the following features. The controller may be operable to drive the motor in the first direction for the first time period until a first tool parameter reaches a first threshold value and to drive the motor in the second opposite direction for the second time period until a second tool parameter reaches a second threshold value. The first tool parameter may comprise at least one of a first time of operation, a first amount of rotation of the output member, a first rotational speed of the output member, a first amount of torque on the output member, and a first amount of current drawn by the motor, and the first threshold value may comprise at least one of a first time threshold value, a first rotation threshold, a first speed threshold, a first torque threshold, and a first current threshold, respectively. The second tool parameter may comprise at least one of a second time of operation, a second amount of rotation of the output member, a second rotational speed of the output member, a second amount of torque on the output member, and a second amount of current drawn by the motor, and the second threshold value comprises at least one of a second time threshold value, a second rotation threshold, a second speed threshold, a second torque threshold, and a second current threshold, respectively. The controller may be alternatively operable in a driving mode in which the controller is operable to drive the motor in one of the first direction and the direction when the power delivery switch is actuated by a user. A mode change switch may be coupled to the housing and operable by a user to select between the driving mode and the tapping mode. When operating in the tapping mode, the controller may be configured to stop the motor for a third time period between the first time period and the second time period.

In another aspect, a power tool includes a housing and a tool holder rotationally coupled to the housing and configured to interchangeably hold a drill bit, a socket, a fastening bit, a tool bit holder, and a tapping bit. A motor is disposed in the housing and configured to rotationally drive an output member. A power delivery switch is coupled to the housing and actuatable by a user to cause power to be delivered to the motor. A controller is disposed in the housing and coupled to the power delivery switch and to the motor to control power delivery to the motor, wherein the controller is configured to be operable in: (1) a driving mode in which the controller is operable to drive the motor continuously in one direction when the power delivery switch is actuated by a user; and (2) a tapping mode in which the controller is operable to drive the motor in repeating cycle of alternating between driving the motor in a first direction for a first time period until a first tool parameter reaches a first threshold value and driving the motor in a second opposite direction for a second time period until a second tool parameter reaches a second threshold value, while the power delivery switch is continuously actuated.

Implementations of this aspect may include one or more of the following features. The first tool parameter may reach the first threshold value when a first amount of time reaches a first predetermined or user-adjustable time period, and the second tool parameter may reach the second threshold value when a second amount of time reaches a second predetermined or user-adjustable time period. The first tool parameter may reach the first threshold value when a first amount of rotation reaches a first predetermined or user-adjustable rotation amount, and the second tool parameter may reach the second threshold value when a second amount of rotation reaches a second predetermined or user-adjustable rotation amount. The first tool parameter may reach the first threshold value when a first sensed current reaches a first predetermined or user-adjustable current value, and the second tool parameter may reach the second threshold value when a second sensed current reaches a second predetermined or user-adjustable current value. The first tool parameter may reach the first threshold value when a first sensed torque reaches a first predetermined or user-adjustable torque value, and the second tool parameter may reach the second threshold value when a second sensed torque reaches a second predetermined or user-adjustable torque value. The first tool parameter may reach the first threshold value when a first sensed speed reaches a first predetermined or user-adjustable speed value, and the second tool parameter may reach the second threshold value when a second sensed speed reaches a second predetermined or user-adjustable speed value.

A mode change switch may be coupled to the housing and operable by a user to select between the driving mode and the tapping mode. In the tapping mode, the repeating cycle may further include a stopping the motor for a third time period between the first time period and the third time period. In the tapping mode, the repeating cycle may further include stopping the motor for a fourth time period after the second time period and before the next first time period. The values of the first threshold value and the second threshold value may be user adjustable. A wireless communications module may be coupled to the controller. The values of the first threshold value and the second threshold value may be adjustable via a remote computing device configured to wirelessly communicate with the wireless communications module. The first threshold value and the second threshold value may be selected such that the first time period is greater than the second time period. The first threshold value may be selected to be sufficient to cause the tool holder to rotate by more than one full revolution under a no load condition. The controller may cause the motor to rotate at a first constant motor speed during the first predetermined period and at a second constant motor speed during the second predetermined time period. The first constant motor speed and the second constant motor speed may be user adjustable.

In another aspect, an impact power tool includes a housing, a tool holder rotationally coupled to the housing and configured to hold a tapping bit, a motor disposed in the housing and configured to rotationally drive an output member, a power delivery switch coupled to the housing and actuatable by a user to cause power to be delivered to the motor, a transmission coupled to the motor having an output member, an impact mechanism having a hammer coupled to the output member and an anvil coupled to the tool holder, and a controller disposed in the housing and coupled to the power delivery switch and to the motor to control power delivery to the motor. The controller is configured to be operable in a tapping mode in which the controller is operable to drive the motor in repeating cycle of alternating between driving the motor in a first direction for a first time period and driving the motor in a second opposite direction for a second time period, the first time period being sufficient to cause the output member of the transmission to rotate by more than one full revolution, while the power delivery switch remains continuously actuated.

Implementations of this aspect may include one or more of the following features. The controller may be operable to drive the motor in the first direction for the first time period until a first tool parameter reaches a first threshold value and to drive the motor in the second opposite direction for the second time period until a second tool parameter reaches a second threshold value. The first tool parameter may reach the first threshold value when a first amount of time reaches a first predetermined or user-adjustable time period, and the second tool parameter may reach the second threshold value when a second amount of time reaches a second predetermined or user-adjustable time period. The first tool parameter may reach the first threshold value when a first amount of rotation reaches a first predetermined or user-adjustable rotation amount, and the second tool parameter may reach the second threshold value when a second amount of rotation reaches a second predetermined or user-adjustable rotation amount. The first tool parameter may reach the first threshold value when a first sensed current reaches a first predetermined or user-adjustable current value, and the second tool parameter may reach the second threshold value when a second sensed current reaches a second predetermined or user-adjustable current value. The first tool parameter may reach the first threshold value when a first sensed torque reaches a first predetermined or user-adjustable torque value, and the second tool parameter may reach the second threshold value when a second sensed torque reaches a second predetermined or user-adjustable torque value. The first tool parameter may reach the first threshold value when a first sensed speed reaches a first predetermined or user-adjustable speed value, and the second tool parameter may reach the second threshold value when a second sensed speed reaches a second predetermined or user-adjustable speed value.

A mode change switch may be coupled to the housing and operable by a user to select between the driving mode and the tapping mode. In the tapping mode, the repeating cycle may further include a stopping the motor for a third time period between the first time period and the third time period. In the tapping mode, the repeating cycle may further include stopping the motor for a fourth time period after the second time period and before the next first time period. The values of the first threshold value and the second threshold value may be user adjustable. A wireless communications module may be coupled to the controller. The values of the first threshold value and the second threshold value may be adjustable via a remote computing device configured to wirelessly communicate with the wireless communications module. The first threshold value and the second threshold value may be selected such that the first time period is greater than the second time period. The first threshold value may be selected to be sufficient to cause the tool holder to rotate by more than one full revolution under a no load condition. The controller may cause the motor to rotate at a first constant motor speed during the first predetermined period and at a second constant motor speed during the second predetermined time period. The first constant motor speed and the second constant motor speed may be user adjustable.

In another aspect, a power tool for driving threaded fasteners includes a housing, a tool holder rotationally coupled to the housing and configured to hold a tapping bit, a motor disposed in the housing and configured to rotationally drive an output member, a power delivery switch coupled to the housing and actuatable by a user to cause power to be delivered to the motor, a transmission coupled to the motor having an output member configured to drive the tool holder, and a controller disposed in the housing and coupled to the power delivery switch and to the motor to control power delivery to the motor. The controller is configured to be operable in a tapping mode in which the controller is operable to drive the motor in repeating cycle of alternating between driving the motor in a first direction for a first time period and driving the motor in a second opposite direction for a second time period, the first time period being sufficient to cause the output member of the transmission to rotate by more than one full revolution, while the power delivery switch remains continuously actuated.

Implementations of this aspect may include one or more of the following features. The controller may be operable to drive the motor in the first direction for the first time period until a first tool parameter reaches a first threshold value and to drive the motor in the second opposite direction for the second time period until a second tool parameter reaches a second threshold value. The first tool parameter may reach the first threshold value when a first amount of time reaches a first predetermined or user-adjustable time period, and the second tool parameter may reach the second threshold value when a second amount of time reaches a second predetermined or user-adjustable time period. The first tool parameter may reach the first threshold value when a first amount of rotation reaches a first predetermined or user-adjustable rotation amount, and the second tool parameter may reach the second threshold value when a second amount of rotation reaches a second predetermined or user-adjustable rotation amount. The first tool parameter may reach the first threshold value when a first sensed current reaches a first predetermined or user-adjustable current value, and the second tool parameter may reach the second threshold value when a second sensed current reaches a second predetermined or user-adjustable current value. The first tool parameter may reach the first threshold value when a first sensed torque reaches a first predetermined or user-adjustable torque value, and the second tool parameter may reach the second threshold value when a second sensed torque reaches a second predetermined or user-adjustable torque value. The first tool parameter may reach the first threshold value when a first sensed speed reaches a first predetermined or user-adjustable speed value, and the second tool parameter may reach the second threshold value when a second sensed speed reaches a second predetermined or user-adjustable speed value.

A mode change switch may be coupled to the housing and operable by a user to select between the driving mode and the tapping mode. In the tapping mode, the repeating cycle may further include a stopping the motor for a third time period between the first time period and the third time period. In the tapping mode, the repeating cycle may further include stopping the motor for a fourth time period after the second time period and before the next first time period. The values of the first threshold value and the second threshold value may be user adjustable. A wireless communications module may be coupled to the controller. The values of the first threshold value and the second threshold value may be adjustable via a remote computing device configured to wirelessly communicate with the wireless communications module. The first threshold value and the second threshold value may be selected such that the first time period is greater than the second time period. The first threshold value may be selected to be sufficient to cause the tool holder to rotate by more than one full revolution under a no load condition. The controller may cause the motor to rotate at a first constant motor speed during the first predetermined period and at a second constant motor speed during the second predetermined time period. The first constant motor speed and the second constant motor speed may be user adjustable.

Advantages may include one or more of the following. The tapping mode may enable tapping a threaded hole using a tapping bit more effectively and efficiently than by driving in a single direction, or by repeatedly changing between forward and reverse modes of operation in a driving mode. This may also reduce wear and tear on components of a power tool, such as the trigger switch and the forward-reverse switch. Finally, the user may be able to customize tool parameters for the various modes of operation, enabling greater tool control. These and other advantages and features will be apparent from the description, the drawings, and the claims.

### BRIEF DESCRIPTION OF THE DRAWINGS

FIG. 1 is a side view of a first embodiment of a power tool.

FIG. 2 is a schematic block diagram of components of the power tool of FIG. 1.

FIG. 3 is a flow chart illustrating an embodiment of operation of the power tool of FIG. 1.

FIGS. 4A and 4B are graphs showing operation of the power tool of FIG. 1 in the forward driving mode of FIG. 3.

FIGS. 5A and 5B are graphs showing operation of the power tool of FIG. 1 in the reverse driving mode of FIG. 3.

FIGS. 6A and 6B are graphs showing operation of the power tool of FIG. 1 in the tapping mode of FIG. 3.

FIG. 7 is a flow chart illustrating another embodiment of operation of the power tool of FIG. 1.

FIGS. 8A and 8B are graphs showing operation of the power tool of FIG. 1 in the tapping mode of FIG. 7.

FIG. 9 is a schematic view of a graphical user interface of a computing device for use with the power tool of FIG. 1.

FIG. 10 is a side view of a second embodiment of a power tool.

FIG. 11 is a schematic block diagram of components of the power tool of FIG. 10.

### DETAILED DESCRIPTION

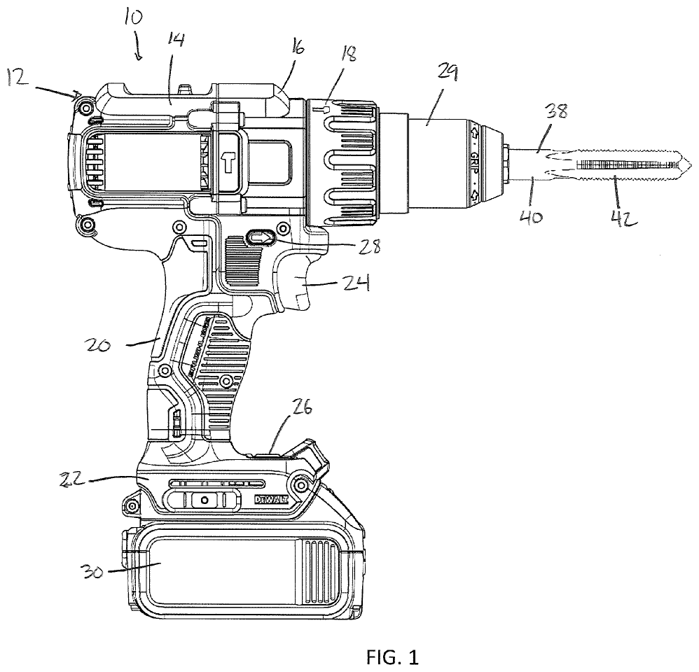

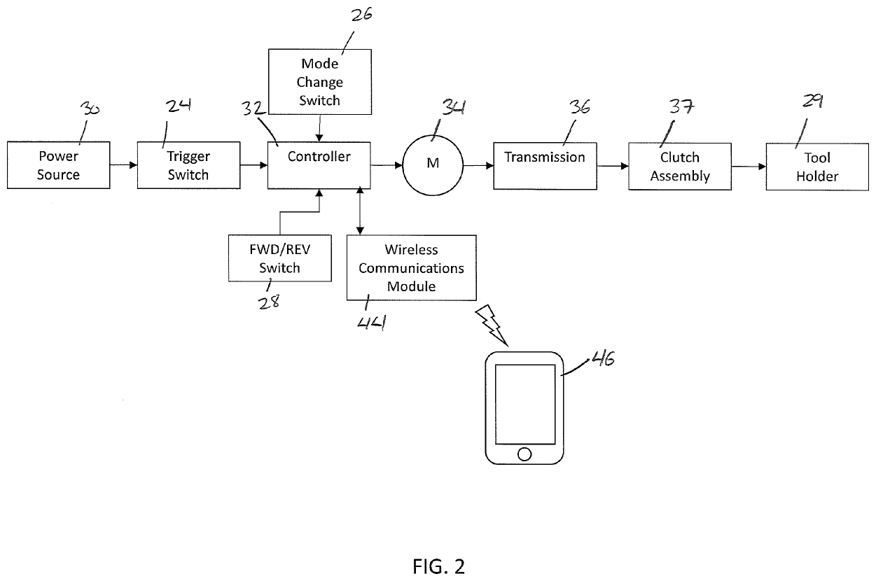

Referring to FIGS. 1 and 2, in an embodiment, a hand-held power tool 10, e.g., a cordless drill, includes a housing 12 that includes a motor housing 14, a transmission housing 16 extending axially forward of the motor housing 14, a clutch housing 18 extending axially forward of the transmission housing 16, a handle 20 extending transversely downward from the motor housing 14 and the transmission housing 16, and a battery receptacle 22 at a base of the handle 20. A power delivery or trigger switch 24 is coupled to the handle 20, a mode change switch 26 is coupled to the battery receptacle 22, and forward/reverse switch 28 is coupled to the housing 12 below the transmission housing 16. A tool holder 28 (e.g., a chuck or a quick release tool holder) is rotationally coupled to the housing 12 in front of the clutch housing 18. The drill 10 may have a design similar to the DEWALT DCD790 20V MAX XR® Compact Drill sold by DEWALT Industrial Tool Co. In other embodiments, the power tool may be a drill driver, a screwdriver, an impact driver, an impact wrench, or another type of rotary power tool.

The battery receptacle 22 is configured to removably receive a power source such as a battery 30, although it should be understood that the battery may not be removable, or the tool may be coupled to alternative power source such as an AC power cord. The handle 20 and/or the motor housing 14 houses a controller 32, which receives inputs from the trigger switch 24, the mode change switch 26, and the forward/reverse switch 28. Optionally, the controller 32 is also electrically in communication with a wireless communication module 44 (e.g., a Bluetooth communications module) received in the housing 12. The wireless communication module 44 is configured to send and receive wireless signals from a computing device 46 (e.g., a smartphone or tablet) so that a user may adjust tool operation parameters via the computing device 46. In other embodiments, the controller, the mode change switch, the trigger switch, and the wireless communications module may be integrated into a single component, multiple but fewer components, and may be implemented in any combination of hardware and software.

The motor housing 14 contains an electric motor 34 (e.g., a brushless DC motor) that receives input from and is controlled by the controller 32. The transmission housing 16 contains a transmission assembly 36 (e.g., a single- or multi-stage, planetary single- or multi-speed transmission), and the clutch housing 18 contains an optional clutch assembly 37 (e.g., with a user adjustable mechanical and/or electronic torque clutch) that are driven by the motor 34, and which transmit rotational motion from the motor 34 to the tool holder 28. The tool holder 28 is configured to interchangeably hold a variety of working tools, such as drill bits, threaded fastening bits, sockets, tool bit holders, and tapping bits. For example, FIG. 1 shows an exemplary tapping bit 38 received in the tool holder 18. The tapping bit 38 includes a shank 40 at least partially received in the tool holder 18 and a thread cutting portion 42 configured to form threads in a workpiece.

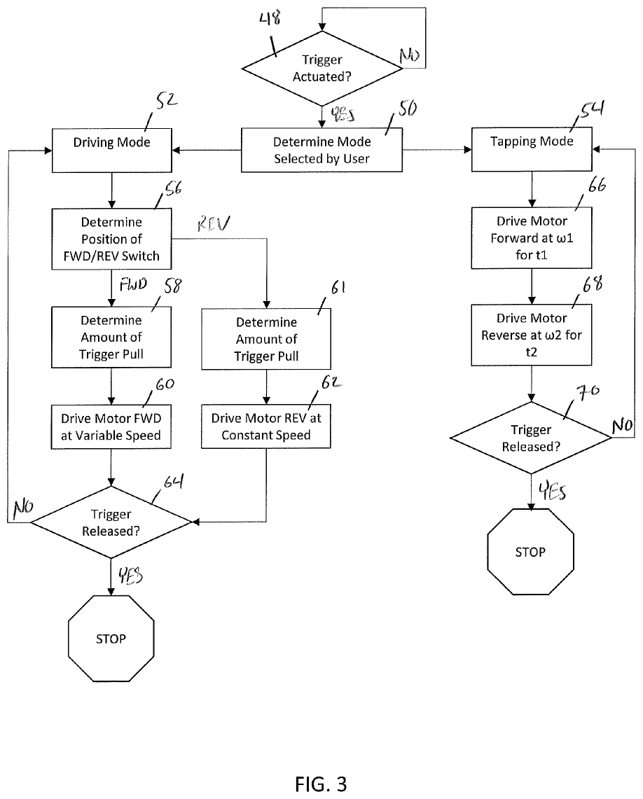

Referring also to FIG. 3, in use, the controller 26 controls power delivery from the battery 30 to the motor 34 and operation of the motor 34 in accordance with user operation of one or more of the trigger switch 24, the mode change switch 26, and the forward/reverse switch 28. First, at step 48, the controller 32 determines whether the trigger switch 24 has been actuated by the user. Next, at step 50, the controller determines which mode of operation has been selected by the user using the mode change switch 24. In the illustrated embodiment, the user may use the mode change switch 24 to select between at least a driving mode 52 (for drilling holes or for installing or removing threaded fasteners) and a tapping mode 54 (for tapping threads in a workpiece using a tapping bit), although it should be understood that the mode change switch 26 may be used to select other modes (e.g., constant speed mode, fastening mode, drilling mode, etc.).

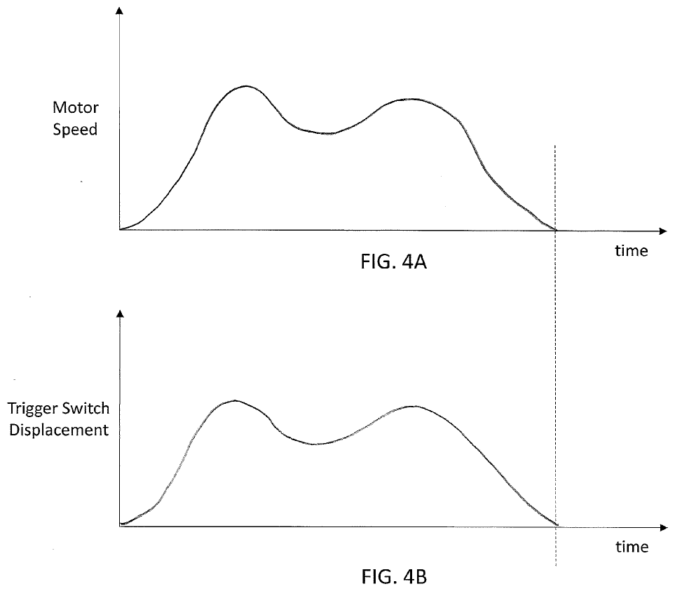

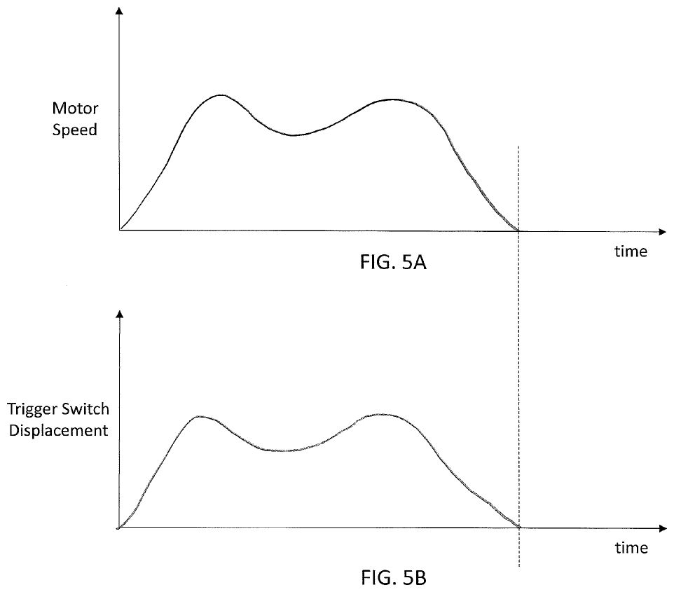

In the driving mode, at step 56, the controller determines the position of the forward/reverse switch 28. If the forward mode has been selected, at step 58, the controller determines the amount that the trigger switch 24 has been actuated or depressed. Then, at step 60, the controller 32 drives the motor 34 in the forward direction (e.g., so that the tool holder 18 rotates clockwise) at a variable speed that is a function of the trigger switch position. For example, the motor speed may be proportional to the trigger switch position, or may be another function such as stepped, exponential, or another mathematical function. If it is determined, at step 56, that the reverse mode has been selected, then, at step 62, the controller 32 drives the motor at a variable speed in a reverse direction, so that the tool holder 18 rotates counterclockwise at a variable speed related to an amount of displacement of the trigger switch 24. In an alternate embodiment, the controller 32 may drive the motor 34 at a substantially constant (e.g., high) speed in reverse, regardless of the amount of trigger switch 24 displacement. The controller 32 continues to drive the motor 34 until it determines, at step 64, that the trigger switch has been released. FIGS. 4A, 4B, 5A, and 5B graphically illustrate operation of the tool in the forward and reverse driving modes. In alternate embodiments, the user may adjust the speed or duration when the controller 32 drives the motor 34, based on user input from the computing device 46 via the wireless communication module 44. The driving mode may be used, e.g., to drill holes in a workpiece and/or to drive or remove threaded fasteners from a workpiece.

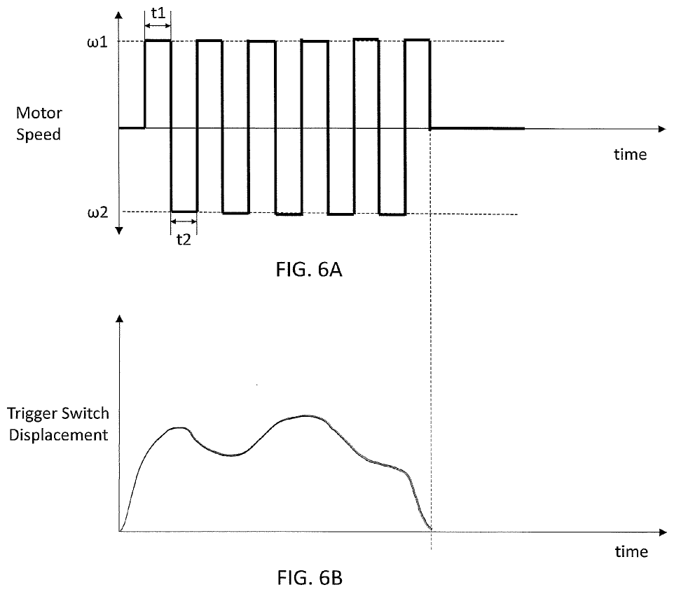

Referring to FIGS. 3 and 6, in an exemplary embodiment of the tapping mode 54, at step 66, while the trigger switch 24 is actuated, the controller 32 first drives the motor 34 in a first direction (e.g., in a direction so that the tool holder 18 rotates to drive a tapping bit into a workpiece) at a first speed ω1 for a first time period t1. In one implementation, the first speed ω1 is constant regardless of the amount that the trigger switch 24 is depressed, although in other implementations the first speed ω1 could be variable based on a magnitude of trigger switch displacement. In the illustrated embodiment, time period t1 may be sufficient so that the controller 32 drives the motor 34 to cause at least one of an output of the transmission assembly 36 to rotate by at least one full revolution under any load, or the tool holder 18 to rotate by at least one full revolution under no load. Next, at step 68, while the trigger switch 24 continues to be actuated without release, the controller 32 drives the motor 34 in a second direction (e.g., in a direction opposite the first direction to remove a tapping bit from the workpiece) at a second speed ω2 for a second time period t2. In the illustrated implementation, the second speed ω2 is constant regardless of the amount that the trigger switch 24 has been depressed, although in other implementations the second speed ω2 may be variable based on an amount of trigger switch displacement. While the trigger switch 24 remains continuously actuated, the controller 32 continues to cycle between alternately driving the motor in a forward direction (step 66) and in a reverse direction (step 68) until the controller determines, at step 70, that the trigger switch 24 has been released. An illustration of operation of the tool in this embodiment of the tapping mode is shown in FIGS. 6A and 6B. In these illustrations, the forward motor speed ω1 and the first predetermined time period t1 are larger in magnitude than the reverse motor speed ω2 and the second predetermined time period t2, respectively. This cycling enables the tapping bit to clear chips from threads being cut by the tapping bit, without the user being required to manually change the position of the forward/reverse switch.

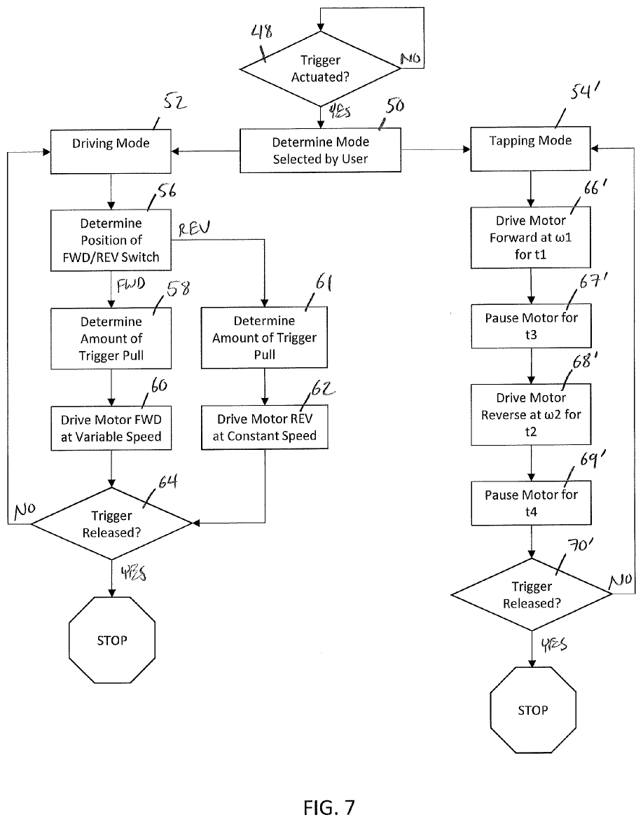

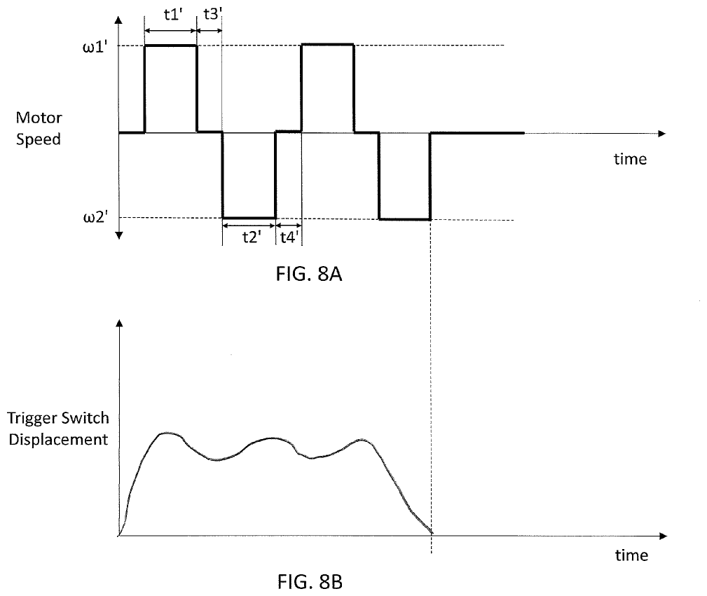

Referring to FIGS. 7 and 8A-8B, in another exemplary embodiment of the tapping mode 54′, when the trigger switch 24 is actuated, at step at step 66′, the controller 32 first drives the motor 34 in a first direction (e.g., in a direction so that the tool holder 18 rotates to drive a tapping bit into a workpiece) at a first speed ω1′ for a first time period t1′. In one implementation, the first speed ω1′ is constant regardless of the amount that the trigger switch 24 is depressed, although in other implementations the first speed ω1′ could be variable based on trigger switch displacement. In the illustrated embodiment, time period t1′ may be sufficient so that the controller 32 drives the motor 34 to cause at least one of an output of the transmission assembly 36 to rotate by at least one full revolution under any load, or the tool holder 18 to rotate by at least one full revolution under no load. Next, while the trigger switch 24 continues to be actuated without being released, at step 67′, the controller 32 stops driving the motor 34 for a third predetermined time period t3′. Then, while the trigger switch 24 continues to be actuated without being released, at step 68′, the controller 32 drives the motor 34 in a reverse direction (e.g., in a direction opposite the first direction to remove a tapping bit from a workpiece) at a second speed ω2′ for a second time period t2′. In the illustrated implementation, the second speed ω2′ is constant regardless of the amount that the trigger switch 24 has been depressed, although in other implementations the second speed ω2 may be variable based on trigger switch displacement. Finally, at step 69′, while the trigger switch 24 continues to be actuated without being released, the controller 32 stops driving the motor 34 for a fourth predetermined time period t4′. While the trigger switch 24 is continuously actuated without being released, the controller 32 continues to cycle through steps 66′-69′ until the controller determines, at step 70′, that the trigger switch 24 has been released. In the illustrated embodiment, the first motor speed ω1′ and the first time period t1′ are larger in magnitude than the second motor speed ω2′ and the second time period t2′, respectively, and both the first and second time periods t1′ and t2′ are longer than the third and fourth time periods t3′, t4′, which may be equal to each other. This cycling enables the tapping bit to clear chips from threads being cut by the tapping bit, without the user being required to manually change the position of the forward/reverse switch.

In the illustrated embodiments of FIGS. 3, 6, 7, and 8, the controller cycles between driving the motor in the first direction and the second direction based on the time periods t1, t1′, t2, t2′ elapsing. In the illustrated embodiments, the time periods t1, t1′, t2, t2′ may be fixed and/or may be user adjustable. In alternative embodiments, the controller may cycle between driving the motor in the first direction and the second direction based on a determination or one or more other tool parameters. For example, the controller may switch between driving in the first and second directions based on a sensed current exceeding a fixed or user-adjustable threshold value, which may indicate that a certain torque level has been reached or that the motor has reached or is approaching a stall condition. Alternatively, the controller may switch between driving in the first and second directions based on a torque sensor in one of the motor, the transmission, the clutch assembly, and the tool holder exceeding a fixed or user-adjustable threshold value. In yet another alternative, the controller may switch between driving in the first and second directions based on a number of rotations of the motor or the speed of the motor, transmission assembly, clutch assembly, or tool holder reaching, exceeding, or dropping below a fixed or user-adjustable threshold value.

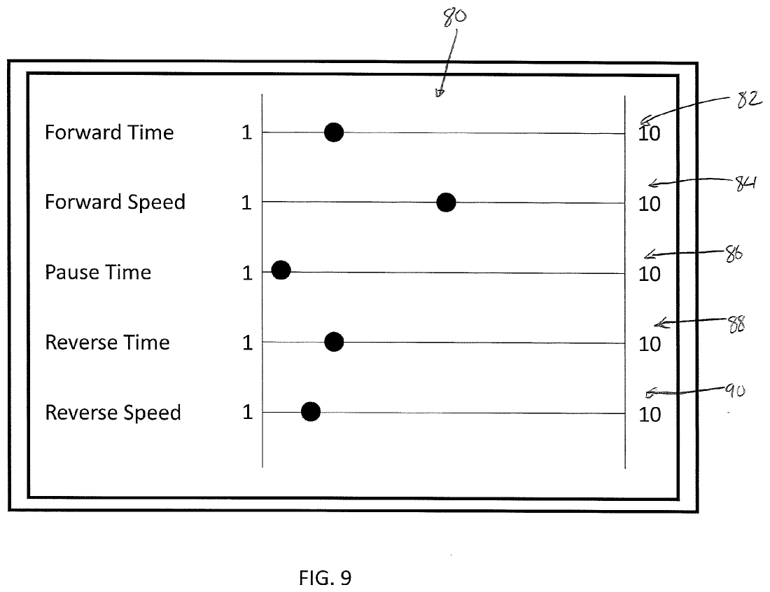

Referring also to FIG. 9, in another implementation, a computing device 46 may be used to communicate with the optional wireless communication module 44 in the housing, so that a user may adjust parameters of the modes of operation. For example, in an embodiment shown in FIG. 9, the computing device 46 may run an app with a user interface 80 that enables a user to adjust parameters of the tapping mode. As shown in this example, the user interface 80 of the app includes a first slider 82 that enables a user to adjust the duration of the time t1 for forward motor operation, a second slider 84 that enables a user to adjust the motor speed ω1 during forward operation, a third slider 86 that enables a user to adjust the durations of the times t3, t4 of the motor pause, a fourth slider 88 that enables a user to adjust the duration of the time t3 for reverse motor operation, a fifth slider 90 that enables a user to adjust the motor speed ω2 during reverse operation. It should be understood that the app and/or user interface may allow the user to adjust other parameters (such as the ones mentioned in the previous paragraph) of each mode of operation, and to save a plurality of different customized settings. The wireless communication module 44 communicates these settings to the controller 32, which drives the motor 34 accordingly.

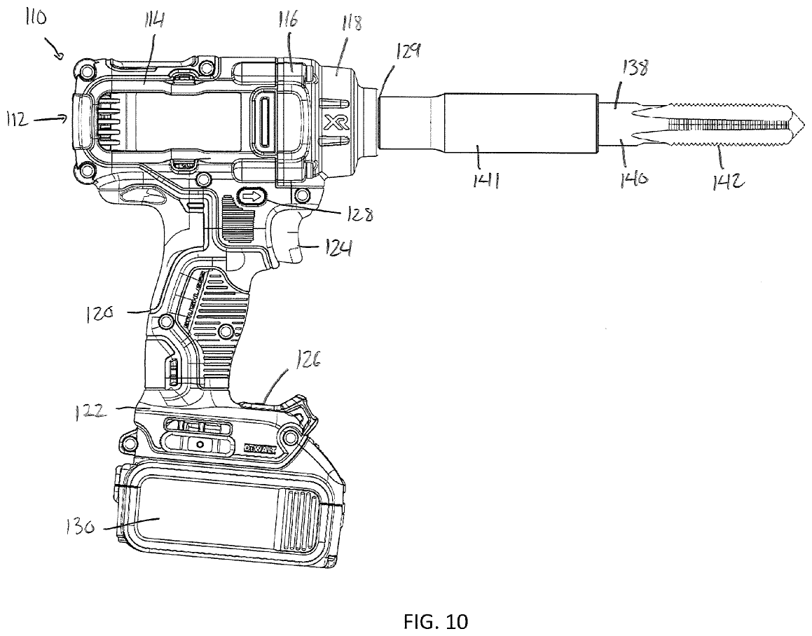

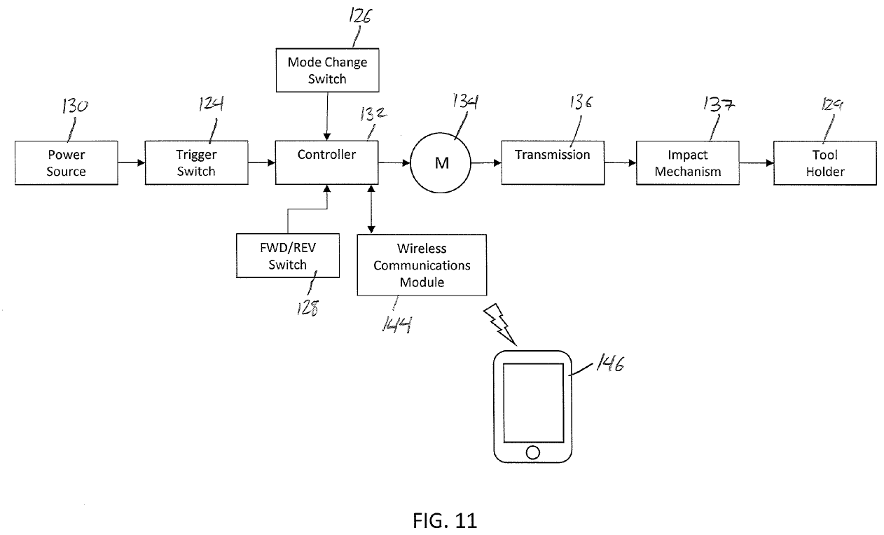

Referring to FIGS. 10 and 11, in an alternate embodiment, a hand-held power tool in the form of a cordless impact driver or impact wrench 110 includes a housing 112 that includes a motor housing 114, a transmission housing 116 extending axially forward of the motor housing 114, a hammer housing 118 extending axially forward of the transmission housing 116, a handle 120 extending transversely downward from the motor housing 114 and the transmission housing 116, and a battery receptacle 122 at a base of the handle 120. A power delivery or trigger switch 124 is coupled to the handle 120, a mode change switch 126 is coupled to the battery receptacle 122, and forward/reverse switch 128 is coupled to the housing 112 below the transmission housing 116. A tool holder 129 (e.g., a quick release tool bit holder or a square drive) is rotationally coupled to the housing 112 in front of the hammer housing 118. The power tool 110 may be similar to the DEWALT DCF886 20V MAX XR® Impact Driver or the DCF894HB 20V MAX XR® Cordless Impact Wrench sold by DEWALT Industrial Tool Co.

The battery receptacle 122 is configured to removably receive a power source such as a battery 130, although it should be understood that the battery may not be removable, or the tool may be coupled to alternative power source such as an AC power cord. The handle 120 and/or the motor housing 114 houses a controller 132, which receives inputs from the trigger switch 124, the mode change switch 126, and the forward/reverse switch 128. Optionally, the controller 132 is also electrically in communication with a wireless communication module 144 (e.g., a Bluetooth communications module) received in the housing 112. The wireless communication module 144 is configured to send and receive wireless signals from a computing device 146 (e.g., a smartphone or tablet) so that a user may adjust tool operation parameters via the computing device 146. In other embodiments, the controller, the mode change switch, the trigger switch, and the wireless communications module may be integrated into a single component, multiple but fewer components, and may be implemented in any combination of hardware and software. In other embodiments, the controller, the mode change switch, the trigger switch, and the wireless communications module may be integrated into a single component, multiple but fewer components, and may be implemented in any combination of hardware and software.

The motor housing 114 contains an electric motor 134 (e.g., a brushless DC motor) that receives input from and is controlled by the controller 132. The transmission housing 116 and the hammer housing 118 contain a transmission assembly 136 (e.g., a planetary gear transmission coupled to an output member such as a cam carrier) and a hammer assembly 137 (e.g., a hammer driven by the cam carrier and an anvil, where the hammer drives the anvil under continuous drive under a low load, and intermittently strikes the anvil under a higher load). The output of the hammer assembly 137 is coupled to the tool holder 129 so that the tool holder 129 is driven by the motor 134. The tool holder 129 is configured to interchangeably hold a variety of working tools, such as drill bits, threaded fastening bits, sockets, tool bit holders, and tapping bits. For example, FIG. 9 shows an exemplary tapping bit 138 received in the tool bit holder 141 that is coupled to a square drive tool holder 129. The tapping bit 138 includes a shank 140 at least partially received in the tool holder 118 and a thread cutting portion 142 configured to form threads in a workpiece.

The power tool 110 is operable in the same manner with the same modes of operation as the power tool 10, described above. For example, in a driving mode, the controller may determine the position of the forward/reverse switch 128. If the forward mode has been selected, the controller may determine the amount that the trigger switch 124 has been actuated or depressed. Then, the controller 132 may drive the motor 134 in the forward direction (e.g., so that the tool holder 129 rotates clockwise) at a variable speed that is a function of the trigger switch position. The motor speed may be proportional to the trigger switch position, or may be another function such as stepped, exponential, or another mathematical function. Alternatively, the controller 132 may drive the motor 134 at a substantially constant speed. If it is determined, that the reverse mode has been selected, the controller 132 may drive the motor at a constant (e.g., high) speed in a reverse direction, so that the tool holder 129 rotates counterclockwise at a constant speed regardless of the amount that the trigger switch 124 has been actuated or depressed). Alternatively, in the reverse mode, the controller 132 may drive the motor at a variable speed in accordance with displacement of the trigger switch 124. The controller 132 may continue to drive the motor 134 until it determines that the trigger switch 124 has been released. In alternate embodiments, the user may adjust the speed or duration when the controller 132 drives the motor 134, based on user input from the computing device 146 via the wireless communication module 144. The driving mode may be used, e.g., to drill holes in a workpiece and/or to drive or remove threaded fasteners from a workpiece.

In a tapping mode, when the trigger switch 124 is actuated, the controller 132 may drive the motor 134 in a first direction (e.g., in a direction so that the tool holder 129 rotates to drive a tapping bit into a workpiece) at a first speed ω1 for a first time period t1. In one implementation, the first speed ω1 may be constant regardless of the amount that the trigger switch 124 is depressed, although in other implementations the first speed ω1 could be variable based on trigger switch displacement. The time period t1 may be sufficient so that the controller 132 drives the motor 134 to cause the output (cam carrier) of the transmission assembly 136 to rotate by at least one full revolution under any load, or the tool holder 129 to rotate by at least one full revolution under no load. Next, while the trigger switch 124 continues to be actuated, the controller 132 may drive the motor 134 in a second direction (e.g., in a direction opposite the first direction to remove a tapping bit from the workpiece) at a second speed ω2 for a second time period t2. In the illustrated implementation, the second speed ω2 is constant regardless of the amount that the trigger switch 124 has been depressed, although in other implementations the second speed ω2 may be variable based on trigger switch displacement. While the trigger switch 124 is continuously actuated without being released, the controller 132 may continue to cycle between alternately driving the motor in a forward direction and in a reverse direction until the controller determines that the trigger switch 124 has been released. In other exemplary embodiments of the tapping mode, the cycles of the controller 132 driving the motor 134 in the first direction and the second direction (e.g., in a direction so that the tool holder 18 rotates to drive a tapping bit into a workpiece) are separated by pauses in which the controller 132 stops driving the motor 134 for a third time period t3 between a first time period t1 and the next consecutive second time period t2 and for a fourth time period t4 between a second time period t2 and the next consecutive first time period t1. This cycling enables the tapping bit to clear chips from threads being cut by the tapping bit, without the user being required to manually change the position of the forward/reverse switch.

In the tapping mode for the impact driver or impact wrench 110, the time periods t1, t2, t2, t3, t4 may be fixed and/or may be user adjustable. In alternative embodiments, the controller may cycle between driving the motor in the first direction and the second direction based on a determination or one or more other tool parameters. For example, the controller may switch between driving in the first and second directions based on a sensed current exceeding a fixed or user-adjustable threshold value, which may indicate that a certain torque level has been reached or that the motor has reached or is approaching a stall condition. Alternatively, the controller may switch between driving in the first and second directions based on a torque sensor in one of the motor, the transmission, the hammer assembly, and the tool holder exceeding a fixed or user-adjustable threshold value. In yet another alternative, the controller may switch between driving in the first and second directions based on a number of rotations of the motor or the speed of the motor, transmission assembly, clutch assembly, or tool holder reaching, exceeding, or dropping below a fixed or user-adjustable threshold value.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. For example, the power tools may have alternative modes of operation such as drilling modes, fastening modes, clutch modes, and precision driving modes. Also, one or more of additional power tool operation parameters may be adjusted by the user using the wireless computing device. In addition, instead of a wireless communications module, the parameters may be user adjustable using a wired computer connection or by using buttons, dials, or other input devices directly coupled to the power tool.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the exemplary implementations described above. These and other implementations are within the scope of the present application.

What is claimed is:

1. A power tool comprising:
a housing;
a motor disposed in the housing and configured to rotationally drive an output member;
a power delivery switch coupled to the housing and actuatable by a user to cause power to be delivered to the motor;
a tool holder configured to be rotatably driven by the output member, the tool holder configured to rotatably drive at least one of a drill bit, a socket, a fastening bit, a tapping bit, and a tool holder accessory; and
a controller disposed in the housing and coupled to the power delivery switch and to the motor, the controller configured to control power delivery to the motor in one of a driving mode and a tapping mode as selected by a user;
wherein, in the driving mode, the controller causes the motor to be driven in a first direction when the power delivery switch is actuated by a user, and
wherein, in the tapping mode, the controller causes the motor to be driven in alternating directions while the power delivery switch is continuously actuated by a user, such that the motor is driven in the first direction for a first time period until a first tool operation parameter reaches a first threshold value and in an opposite second direction for a second time period until a second tool parameter reaches a second threshold value.

2. The power tool of claim 1, wherein the first tool parameter comprises at least one of a first time of operation, a first amount of rotation of the output member, a first rotational speed of the output member, a first amount of torque on the output member, and a first amount of current drawn by the motor, and the first threshold value comprises at least one of a first time threshold value, a first rotation threshold, a first speed threshold, a first torque threshold, and a first current threshold, respectively.

3. The power tool of claim 2, wherein the second tool parameter comprises at least one of a second time of operation, a second amount of rotation of the output member, a second rotational speed of the output member, a second amount of torque on the output member, and a second amount of current drawn by the motor, and the second threshold value comprises at least one of a second time threshold value, a second rotation threshold, a second speed threshold, a second torque threshold, and a second current threshold, respectively.

4. The power tool of claim 1, further comprising a mode selector switch coupled to the housing and operable by a user to select among a plurality of modes that include the driving mode and the tapping mode.

5. The power tool of claim 1, wherein, when operating in the tapping mode, the controller is configured to stop the motor for a third time period between the first time period and the second time period.

6. The power tool of claim 9, wherein, when operating in the tapping mode, controller is configured to stop the motor for a fourth time period after the second time period and before the next first time period.

7. The power tool of claim 1, wherein each of the first threshold value and the second threshold value are user-adjustable.

8. The power tool of claim 7, further comprising a wireless communications module coupled to the controller, wherein the first threshold value and the second threshold value are user-adjustable via a remote computing device configured to wirelessly communicate with the wireless communications module.

9. The power tool of claim 1, wherein the first threshold value and the second threshold value are selected such that the first time period is greater than the second time period.

10. The power tool of claim 1, wherein the first threshold value is selected to be sufficient to cause the tool holder to rotate by more than one full revolution under a no load condition.

11. The power tool of claim 1, wherein, when operating in the tapping mode, the controller causes the motor to rotate at a first constant motor speed during the first predetermined period and at a second constant motor speed during the second predetermined time period.

12. The power tool of claim 11, wherein the first constant motor speed and the second constant motor speed are user-adjustable.

13. The power tool of claim 1, wherein the power tool comprises one of a drill, a drill-driver, an impact driver, and an impact wrench.

14. A power tool comprising:
a housing;
a motor disposed in the housing and configured to rotationally drive an output member;
a power delivery switch coupled to the housing and actuatable by a user to cause power to be delivered to the motor;
a tool holder configured to be rotatably driven by the output member, the tool holder configured to rotatably drive a tapping bit; and
a controller disposed in the housing and coupled to the power delivery switch and to the motor, the controller configured to control power delivery to the motor in a tapping mode in which the controller causes the motor to be driven in alternating directions while the power delivery switch is continuously actuated by a user, such that the motor is driven in a first direction for a first time period and in an opposite second direction for a second time period, the first time period being sufficient to cause the output member to rotate by more than one full revolution.

15. The power tool of claim 21, wherein the controller is operable to drive the motor in the first direction for the first time period until a first tool parameter reaches a first threshold value and to drive the motor in the second opposite direction for the second time period until a second tool parameter reaches a second threshold value.

16. The power tool of claim 15, wherein the first tool parameter comprises at least one of a first time of operation, a first amount of rotation of the output member, a first rotational speed of the output member, a first amount of torque on the output member, and a first amount of current drawn by the motor, and the first threshold value comprises at least one of a first time threshold value, a first rotation threshold, a first speed threshold, a first torque threshold, and a first current threshold, respectively.

17. The power tool of claim 16, wherein the second tool parameter comprises at least one of a second time of operation, a second amount of rotation of the output member, a second rotational speed of the output member, a second amount of torque on the output member, and a second amount of current drawn by the motor, and the second threshold value comprises at least one of a second time threshold value, a second rotation threshold, a second speed threshold, a second torque threshold, and a second current threshold, respectively.

18. The power tool of claim 14, wherein the controller is alternatively operable in a driving mode in which the controller is operable to drive the motor in one of the first direction and the direction when the power delivery switch is actuated by a user.

19. The power tool of claim 18, further comprising a mode change switch coupled to the housing and operable by a user to select between the driving mode and the tapping mode.

20. The power tool of claim 14, wherein, when operating in the tapping mode, the controller is configured to stop the motor for a third time period between the first time period and the second time period.
